(19) United States
(12) Patent Application Publication
(10) Pub. No.: US 2007/0078552 A1
(43) Pub. Date: Apr. 5, 2007

(54) GAZE-BASED POWER CONSERVATION FOR PORTABLE MEDIA PLAYERS

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/562,082

(22) Filed: Nov. 21, 2006

Related U.S. Application Data
(60) Provisional application No. 60/758,897, filed on Jan. 13, 2006.

(51) Int. Cl. G06F 17/00

(52) U.S. Cl. 700/94

(57) ABSTRACT

A portable media player has a gaze-responsive power conservation feature. The portable media player includes a casing, processor, visual display, audio display, main memory functionally coupled to the processor, and secondary memory functionally coupled to the processor, where the secondary memory has media content retrievably stored therein. A gaze sensor transmits signals to the processor responsive to a gaze of a user. A program has instructions executable by the processor to: (a) present media content to a user by displaying visual content on the visual display and by playing audio content through the audio display; and (b) reduce power consumption of the visual display by lowering an intensity of display output when the gaze sensor indicates the user is not gazing in the general direction of the visual display, while continuing to play audio content to the user through the audio display at a substantially unchanged power level.

### RELATED APPLICATION DATA

This application claims priority to provisional application Ser. No. 60/758,897, filed Jan. 13, 2006, the disclosure of which is hereby incorporated by reference herein in its entirety.

### FIELD OF THE APPLICATION

The present invention relates generally to a method, system, and apparatus for conserving power in a portable media player by detecting a user's gaze and adjusting the display of media in response to the detecting.

### BACKGROUND

Electronic Media Players have become popular personal entertainment devices due to their highly portable nature and interconnectivity with existing computer networks, such as the Internet. The accessibility and simplicity in downloading music files and other electronic media continues to fuel the popularity of these devices as is exemplified by Apple Computer, Inc.'s highly successful iPod™ portable media player. Recent models also allow for the storage and display of personal photos allowing users to carry about a photo album stored in memory of the media player. Other models allow for the storage and display of music videos, movies, and other video content. Some manufacturers have competing Media Players offering various functionalities and file playing compatibilities in an effort to differentiate their products in the marketplace.

As discussed in Apple Computer, Inc., U.S. Patent Application Publication No. 2004/0224638 A1, to Fadell, et al., which is herein incorporated by reference in its entirety, an increasing number of consumer products are incorporating circuitry to play musical media files and other electronic media. Additional embodiments of media players are disclosed in the current applicant's co-pending U.S. Provisional Patent Application Ser. Nos. 60/648,197, filed on Jan. 27, 2005; 60/665,291 filed on Mar. 26, 2005; and 60/651,771, filed on Feb. 9, 2005; the aforementioned provisional applications are hereby incorporated by reference in their entirety.

Many portable electronic devices may include media player functionality and thus may be considered portable media players. For example, many portable electronic devices such as cellular telephones, portable gaming devices, and personal digital assistants (“PDAs”) include the ability to play electronic musical media in many of the most commonly available file formats including Moving Picture Experts Group-1 (“MPEG-1”) Audio Layer 3 (“MP3”), Audio Video Interleave (“AVI”), Waveform audio format (“WAV”), Moving Picture Experts Group (“MPG”), Quicktime (“QT”), Windows™ Media Audio (“WMA”), Audio Interchange File Format (“AIFF”), Audio (“AU”), Real Audio Media (“RAM”), Real Audio (“RA”), Movie files (“MOV”), Musical Instrument Digital Interface (“MIDI”), and so forth.

In the relevant art, portable media players enable users to listen to music as digital audio files and/or as part of digital video files through headphone or speakers. Portable media players also enable users to watch video files upon a screen. The screen is generally integrated into an easily viewable surface of the casing of the portable media player when the media player casing is held in certain ways with respect to the user. Thus there is a substantial difference between the audio output of the portable media player and the video output of the portable media player—the audio output is received by the user regardless of how the visual display surface of the media player is positioned related to the user so long as the user is correctly wearing headphones or is within listening range of the speaker output. Video output, on the other hand, may be presented upon a screen of the media player, but if the user is not looking at the screen, it will not be received by the user. For example, if the media player is clipped to the user's belt, or within the user's pocket, or in the user's backpack, or otherwise positioned such that a clear line of sight does not exist between the screen of the portable media player and the eyes of the user, the user will not be receiving the video content. This is a common situation for users who often keep a media player in their pocket or in their backpack or on their belt for convenience during daily activities, receiving audio content through headphones that are not dependent upon the position of the casing. Thus if a user is playing, for example, a music video, listening to the audio content, but has the media player in his pocket and is therefore not watching the video, the video display content is wasted, thereby resulting in the wasting of the power used to drive the screen of the portable media player when the user is only listening to the audio content of the media file. Because portable media players have limited battery life, it is highly beneficial to eliminate wasted power usage. Thus there is a substantial need for conserving power in situations wherein a user is playing a media file that includes video and audio content but the user only receiving the audio content because he or she is not gazing upon the screen portion of the portable media player.

With respect to computing devices with gaze-detection capabilities, a variety of technologies exist for tracking the direction that a user gazes with respect to a display screen, usually referred to as eye-tracking or gaze-tracking. An early system for tracking eye motion disclosed in U.S. Pat. No. 4,075,657, the disclosure of which is hereby incorporated by reference in its entirety. Over the last few years, the hardware and software required to perform such functions has gotten less expensive, more robust, and has been enabled through progressively smaller and smaller embodiments. This trend is expected to continue to the point where gaze-tracking hardware and software will become inexpensive and thus appropriate for incorporation into within a wide range of low-cost consumer electronics. At the present time, the primary applications of gaze-tracking technology are directed at specialized tools for performing marketing research and other user studies as well as specialized tools for enabling persons with mobility disabilities to interact with computer systems. For example, many applications of gaze-tracking technologies are used to study how people visually explore the information presented on computer screens. These studies, usually performed by marketing researchers and user-interface researchers are geared towards understanding which content on a computer display people spend their time looking at. In the disability field, many applications of gaze-tracking technologies are used to enable individuals who have limited physical mobility to control a computer cursor and/or make other selections within a computer interface by using their eyes as the input control. The gaze-tracking technology determines where the user is looking at controls the cursor to follow their gaze. Often a blink is used to emulate the clicking of a mouse thereby enabling a user to have full cursor control using only their eyes as the input means. For example, a company called “EyeTech Digital Systems” produces such products for disabled users.

A variety of technologies exist for gaze-tracking. These technologies generally employ one or more digital cameras (or other optical sensors) aimed at the eyes of the user. These technologies sometimes also employ a source of lights, sometimes structured light, such that the reflection of the light off the eyes can be captured by the digital camera and used to determine where on the display screen a user is looking at. For example, an eye tracking device has been developed by the IBM Corporation at its Almaden Research Center and is referred to by the acronym MAGIC. This device is mounted proximate to a display screen, in a known positional relationship. When a user is viewing the screen, the IBM eye tracking device determines the point of gaze or focus, with respect to the screen, of the pupils of the user's eyes. Such device generally comprises a camera that acquires successive image frames at a specified rate, such as 30 frames per second. The device further comprises two near infrared time multiplexed light sources, each composed of a set of IR light emitting diodes (LED's) synchronized with the camera frame rate. The system tracks eye focus by detecting the reflection of the emitted light off the user's eyes. Such a process is described in more detail later in this document. One gaze-tracking system for enhancing the usability of portable computing devices that uses such an eye-tracking system is disclosed in pending U.S. Patent Application Publication No. 2003/0038754 which is hereby incorporated by reference. Another gaze-tracking system is disclosed in pending U.S. Patent Application Publication No. 2002/0180799 which is also hereby incorporated by reference. This system is directed at controlling the rate of scrolling of a text document based upon where the user is looking. Another gaze-tracking system that has been more recently developed is disclosed in pending U.S. Patent Application Publication No. 2004/0075645 which is also hereby incorporated by reference. This system is advantageous over some prior art systems in that it only requires a single camera pointed at the user and does not require calibration and lighting control.

Widespread integration of eye trackers into consumer systems requires that eye trackers be easy to use, affordable, accurate, and less constrained by head and body movements of users. Another gaze-tracking system that further addresses these needs is disclosed in U.S. Patent Application Publication No. 2005/0175218 which is hereby incorporated by reference. The aforementioned systems and other recent advances in gaze-tracking are expected to increase the robustness and decrease the size and cost of gaze-tracking systems available in consumer markets. As the current trends continue, gaze-tracking systems are expected to soon be appropriate for mainstream consumer products.

A subset of gaze-tracking is sometimes referred to as gaze-detection. Gaze detection uses the same hardware and software techniques but requires significantly less precision and speed in the hardware and software components. This is because a gaze detection system only needs to determine if a users gaze is inside a particular boundary and does not need to resolve the specific location of the user's gaze within that boundary. For example, a gaze-detection system of the present invention may be configured to detect if a user's gaze is aimed upon or substantially near a display area of a portable media player but does not need to further resolve where upon the display area the gaze is directed.

### SUMMARY

A portable media player is provided that is equipped with both audio and video display capabilities and can simultaneously present both the audio and video content of a media file to a user, such as a music video that includes both audio and video media content. Because a typical portable media player with video display capabilities generally includes the display screen in a handheld casing, the video content may not be easily viewed by the user in many common usage configurations. For example, the main casing of the portable media player is often stored in a pocket of the user, clipped to the belt of a user, held in a backpack of the user, or otherwise positioned such that the user cannot easily view the video screen on the casing of the media player. The user is still likely to be listening to the audio content of the media file during such times, such as the music track of a music video. Thus, in such a situation in which a user is listening to the audio track of a music video or other media file but is not looking at the screen, power is wasted to illuminate and/or drive the display screen hardware. In fact, such visual display related power is wasted any time the media player is playing combined audio and image content and the user is not looking at the display screen, instead only listening to the audio content. Because a portable media player has limited battery life, power consumption is a concern. Thus, embodiments of the present invention are aimed at reducing this waste in power consumption by dimming and/or turning off the illumination of a display screen and/or turning off other components related to a display screen on the casing of a portable media player (while keeping the audio stream playing) at moments in time when it is determined that the user's gaze is not aimed substantially in the direction of the display screen.

Thus, embodiments of the present invention are directed to a method, apparatus, and computer program for conserving power consumed by the screen of a portable media player by automatically dimming and/or turning off the illumination of a visual display and/or reducing power sent to display related components of a portable media player during certain periods of time while keeping the audio content playing to the user over those periods. In this way, the user may continue to listen to the audio content, but power is saved by reducing power consumed on the display and supporting components of the portable media player. More specifically, embodiments of the present invention provide a system for automatically dimming and/or turning off the illumination of a display screen of a portable media player and/or reducing power sent to visual display related components of a portable media player during periods of time when it is determined that the user's gaze is not aimed substantially in the direction of the display screen while keeping the audio content playing to the user over those periods of time. In this way the user may continue to listen to the audio content, but power is saved by reducing power consumption of the display related components of the portable media player.

Embodiments of the present invention provide a gaze-based system for automatically dimming and/or turning off the illumination of a visual display of a portable media player and/or reducing the power consumed by display-related components in response to a determination that a user is not gazing upon a display portion of the portable media player, while keeping the audio content playing to the user over that period of time. The determination as to whether a user is gazing upon a display portion of the portable media player is made at least in part by assessing data generated by a gaze-detection system incorporated within the portable media player. In some preferred embodiments of the present invention the method for dimming and/or turning off the illumination of a display portion of a portable media player and/or reducing power consumed by display related components of the portable media player is performed in response to a determination that a user has not gazed upon a display portion of the portable media player for more than a first threshold amount of time. In this way a user may glance away from the screen for less than the threshold amount of time and not have the display be dimmed and/or turned off. Similarly, in some preferred embodiments of the present invention the method for resuming the normal display of video upon a portable media player after a user has looked away includes determining that the user has returned his gaze upon a display portion of the portable media player for more than a second threshold amount of time. In this way a user may momentarily glance upon the display and not have it turn on unless the glance lasts for more than the threshold amount of time. In some embodiments, the first threshold and the second threshold are set to the same amount of time. In some preferred embodiments the first threshold is set to a substantially longer amount of time than the second threshold. This allows the portable media player visual display to automatically dim and/or turn off after the user has looked away for longer period of time than is require for the user to return his or her gaze to the visual display and cause the visual display to return to a standard illumination level.

Thus, one aspect of embodiments of the present invention is the use of a time threshold such that the display screen is not dimmed and/or turned off unless it is determined by the gaze determination hardware and software of the present invention that the user has looked away from a visual display area for more than a first threshold amount of time. In some embodiments of the present invention, the first threshold amount of time is set to 6 seconds. This threshold is referred to herein as a look-away time threshold.

In some embodiments the illumination level is dimmed over a period of time, either continuously or in discrete steps, until it reaches final dimmed illumination level. In many embodiments the final dimmed illumination level may be such that no illumination is produced by the display, thereby conserving power at a maximized level. The period of time over which the illumination is dimmed is referred to herein as a dimming time and it may, for example, be set to 30 seconds.

Upon determining using the gaze determination hardware and software of the present invention that a user has looked away from the visual display area for more than the look-away threshold amount of time, the visual display is dimmed and/or turned off (while the audio continues to play) by the control software until it is determined that the user's gaze has returned to the visual display area. In some embodiments a second time threshold value is used such that the user must return his or her gaze to the visual display area for more than this second time threshold amount of time for the visual display to return to a standard illumination level. This prevents the illumination level to resume in response to a fleeting glance from the user. In general this second amount of time is selected long enough such that it will not trigger a change in the display illumination characteristics by fleeting glance, but short enough that a user does not feel like time is being wasted while he or she waits for the visual display characteristics to resume to a comfortably viewable configuration. In some embodiments this second threshold amount of time is set to 1750 milliseconds. This second threshold is referred to herein as a resume time threshold.

Embodiments of the present invention also apply to audio content having a relational associated text and/or still images that may be displayed when the audio content is playing. For example, many media players are configured such that when a piece of music content is playing, a certain set of text and/or image data is displayed upon a screen or other visual display. Text data may include the name of the song, the album of the song, the name of the artist, the type of music genre, the time duration of the song, or the source from which the media file was accessed. Image data may include a picture of the album cover, a picture of the artist, or another picture or set of pictures that is relationally associated with the song, album, artist, genre, or source of the media file. It is a waste of energy to brightly display such text and/or image data during the entire time that a music file may be playing. That said, a user may wish to look at the screen for a brief moment during the playing of a music file to quickly check the name of the song, album, artist, genre, the play time duration, or other relationally associated textual and/or image content. It would often be inconvenient if the user had to deliberately press a button to brighten and/or turn on the display just to check such visual information. Embodiments of the present invention solve this problem through a natural and intuitive user interface method, selectively brightening and/or turning on the visual display of a portable media player based upon the detection of a user-gaze at, upon, or near a display area of the portable media player. In this way the display may be dimmed and/or turned off while the user is listening to audio content except for a period of time when the user aims his or her gaze upon the display, at which time the visual information is provided in combination with the audio content. Such a unique method and apparatus is operative to conserve power while maintaining substantial ease of use for the user.

Finally, a person of ordinary skill in the art would appreciate that the methods and apparatus of the present invention are applicable to media player devices that retrieve media content from a local store of media content as well as to media player devices that receive media content from an external source such as a real-time broadcast of media content over satellite radio or some other communication channel. In some such embodiments the data may be received from a particular web URL, satellite radio station, or other external source and the user may wish to view the source information from where the data was received by looking at the display screen. The methods and apparatus as described herein allow such viewing to be performed using the gaze-responsive power saving features of the present invention.

The media player of embodiments of the preset invention includes a gaze tracking system (referred to herein as a gaze determination system) or other similar eye gaze sensing device that is configured to determine whether the user's gaze falls upon, within, or substantially near an area that corresponds with a display screen of the portable media player. Such an area is referred to herein as the visual display area although it is understood that the area need to exactly correspond with the dimensions of the display screen. The key is to define a visual display area with respect to the media player casing such that if the user's gaze is aimed within, upon, or substantially near the visual display area it can be assumed that the user is viewing the media player and if the user's gaze is not aimed within, upon, or substantially near the visual display area it can be assumed that the user is not viewing visual content from that display screen of the media player.

Embodiments of the present invention may employ lower cost components and less computationally intensive software routines than a high-resolution gaze-tracking system of the current art. Thus the cost, complexity, and computational burden required of the gaze-detection system implemented for the present invention is significantly reduced. Thus embodiments of the present invention can be enabled using a high resolution gaze tracking system or a lower performance embodiment referred to herein as a gaze-detection system, a gaze detection system having at least the capability of determining if a user's gaze is aimed at or substantially near a defined display area of the portable media player of the present invention.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a generalized block diagram of a portable media player according to at least one embodiment of the invention;

FIG. 2 illustrates a portable media player equipped with a gaze-detecting sensor of a gaze determining system integrated into to the casing according to at least one embodiment of the invention; and

FIG. 3 illustrates an exemplary flow chart for an example power conservation method according to at least one embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Over recent years, portable media devices have come to include a plurality of output technologies for presenting media content to users. The output technologies include both a visual display and an audio display. The visual display generally includes a screen such as an LCD or plasma screen. The audio display typically includes a sound amplifier and headphones and/or speakers. In general, both audio and visual displays are operative concurrently, presenting information to users through visual and audio modes simultaneously. This is often necessary and valuable. However, there are substantial amounts of time during the usage of a portable media player that power is wasted on the visual display. This is because there is substantial time during the usage of a portable media player that a typical user will listen to the audio content but not look at the video content. In other words, the portable media player may be playing video media which includes both audio and visual content, but there may be substantial amounts of time that a user is only listening to the audio content and ignoring the video content. For example, a user may be playing a music video but only listening to the music portion during some or all of the time during which the music video is played. As a result power is wasted upon the visual display. This is problematic because the battery life of a portable media player is limited and the video display consumes a large portion of the total power consumed by the device. Thus, to conserve power and increase the battery life of portable media devices, embodiments of the present invention provide an automatic means of dimming and/or turning off the illumination of the visual display at moments in time when a user is determined not to be viewing the video content. More specifically, embodiments of the present invention provide a gaze sensing system within the portable media device.

The gaze sensing system determines whether the portable media device is being viewed by a user and if not, dims and/or turns off the illumination of the visual display while keeping the audio portion of the content playing. This conserves power. Thus, a user may use the portable media device in a natural manner, gazing at the device when desiring to view visual content and looking away when not desiring visual content, and the device automatically conserves power used to drive the visual display based at least in part upon the detected gaze of a user. The device also includes an over-ride interface by which a user may deliberately turn on or turn off the visual display while leaving the audio display active. In this way the user may bypass the automatic power consumption regulation methods and apparatus provided by the current invention.

A portable media player is provided that is equipped with both audio and video display capabilities such that it can simultaneously present both the audio and video content of a media file to a user. For example, a music video media file that includes both audio and video media content may be displayed to the user through such a portable media player. The audio content may be presented through headphone or speakers, and the video media content displayed through a screen mounted within or upon the casing of the portable media player. The media file may be accessed locally from memory and/or may be received as a data stream over a communication link. The portable media player may also be equipped such that it can play an audio file simultaneously with the visual display of relationally associated textual and/or image data such as title, artist, album, source, name, author, and other factual information and/or album cover imagery, artist imagery, and/or other pictorial imagery that is relationally associated with the audio file and/or data. The portable media player may also display other content upon a visual display area such as elapsed time of media play, current clock time, and/or other personal information such as information relating to communication and schedules.

Embodiments of the present invention are relevant to any portable electronic device that either is a dedicated media player or provides media player functionality by accessing digital audio and/or video files from a local memory store (or from an external source over a communication link) and plays the files for users to experience perceptually.

Because a typical portable media player with video display capabilities generally includes the display screen in a handheld casing, the user may not easily view the video content when the casing is kept in certain positions and/or orientations with respect to the user. For example, the casing of the portable media player may be stored in a pocket of the user, clipped to the belt of a user, held in a backpack of the user, or otherwise positioned such that the user cannot easily view the video screen on the casing of the media player. Still, the user is likely to be listening to the audio content of the media file, such as the music track of a music video. Thus in such situations in which a user is listening to the audio track of a video media file but is not looking at the visual display screen, power is wasted to illuminate and/or drive the display screen hardware. Because a portable media player has limited battery life, power consumption is a concern. Thus, embodiments of the present invention are aimed at reducing this waste in power consumption by dimming and/or turning off the illumination of a display screen of the portable media player and/or reducing power sent to visual display related components of a portable media player (while keeping the audio stream playing) at moments in time when the user is not gazing at, upon, or substantially near the visual display area. In this way a portable media player according to the present invention is configured to play video media file that includes both audio and visual content such that the audio content is played continuously over a period of time through audio output hardware of the portable media player and yet the video content is selectively output by the visual display hardware of the portable media player over that same period of time based upon a detected gaze of a user being directed at, upon, or substantially near the visual display area. Thus the audio stream continues to play normally to the user when the video display is automatically dimmed or turned off by the gaze-based power conservation feature. This allows the audio content to continue to play to the user at a substantially unchanged power level while the power is reduced to the video display. The user therefore experiences audio content that seems substantially unchanged (i.e., it continues to play normally), while the video content is automatically dimmed or turned off

Thus, embodiments of the present invention are directed to a method, apparatus, and computer program for conserving the power consumed by visual display hardware of a portable media player by automatically dimming and/or turning off the display during certain periods while keeping the audio content playing to the user over those periods. The automatic dimming and/or turning off of the display is based at least in part upon a detected gaze of a user. In this way the user may continue to listen to the audio content while not looking at the display screen, and power is saved by reducing power consumed on the screen of the portable media player. In addition, embodiments of the present invention may be configured such that even when a media file is being played that is primarily or exclusively audio in content, the display screen of the portable media player is controlled to selectively illuminate and/or display relationally associated textual and/or image data such as title, artist, genre, album, duration, and/or rating information, based upon a detected gaze of the user. Embodiments of the present invention may also be configured such that the current time, current schedule, and/or current user messaging information is selectively displayed and/or illuminated upon a display screen of the portable media player based upon a detected gaze of the user. In this way, numerous embodiments of the present invention control the illumination level and/or power supplied to display hardware by a processor of the portable media player in response to detected gaze information about the user. More specifically, embodiments of the present invention reduce the illumination level and/or power supplied to display hardware when it is determined that a user's gaze is not at, upon, or substantially near the visual display area and/or has not been at, upon, or substantially near the visual display area for more than some defined threshold amount of time.

In general, the power saving features and functions of embodiments of the present invention are controlled by control software running upon a processor of the portable media player. Where necessary, computer programs, algorithms and routines are envisioned to be programmed in a high level language object oriented language, such as Java™ C++, C#, or Visual Basic™.

In some preferred embodiments of the present invention the determination as to whether or not the user's gaze is at, upon, or substantially near a defined visual display area of the portable media player is performed by collecting data from a Gaze Determination System that includes a camera and/or other optical sensor component. In some preferred embodiments the Gaze Determination System includes an optical emitter in which electromagnetic energy is emitted and bounced off the eyes of a user as part of the gaze determination process. In general, the Gaze Determination System may be a gaze tracking system of a configuration known to the art. High-resolution positional tracking is not required to achieve embodiments of the invention. Lower cost and/or lower performance gaze tracking hardware and software may be employed as compared to other applications in the art.

The media player also includes hardware and/or software for processing the data collected and/or generated by the Gaze Determination System and responding accordingly to perform the inventive power saving features disclosed herein. For example, the hardware and/or software of the portable media player of the present invention may maintain audio output of a media file to the audio hardware of the media player while selectively displaying and/or illuminating video content of the media file based upon the data collected and/or generated by the Gaze Determination System.

Embodiments of the present invention address the need for power conservation by providing a system for conserving power sent to the screen of a portable media player by automatically dimming and/or turning off the illumination of and/or the other power consuming portions of the display portion of a portable media player over a period of time while keeping the audio content playing to the user over that period of time. In this way the user may continue to listen to the audio content, but power is saved by reducing the power consumption of the screen portion of the portable media player. More specifically, embodiments of the present invention provide a gaze-based system for automatically dimming and/or turning off the screen of a portable media player over a period of time (while continuing to play audio content) in response to a determination that a user is not gazing upon a screen portion of the portable media player. The determination is made at least in part by assessing data generated by a gaze-detecting system incorporated within the portable media player. Embodiments of the present invention also apply to audio content that has a relational associated text and/or still images that may be displayed when the audio content is playing. For example, many media players are configured such that when a piece of music content is playing, a certain set of text and/or image data is displayed upon a screen or other visual display. It is a waste of energy to brightly display such text and/or image data during the entire time that a music file may be playing. That said, a user may wish to look at the screen for a brief moment during the playing of a music file to check the name of the song, album, artist, genre, or other relationally associated textual and/or image content. Embodiments of the present invention solve this problem by selectively brightening and/or turning on the visual display of a portable media player in response to the detection of a user-gaze that is aimed at, upon, or substantially near a display area of the portable media player.

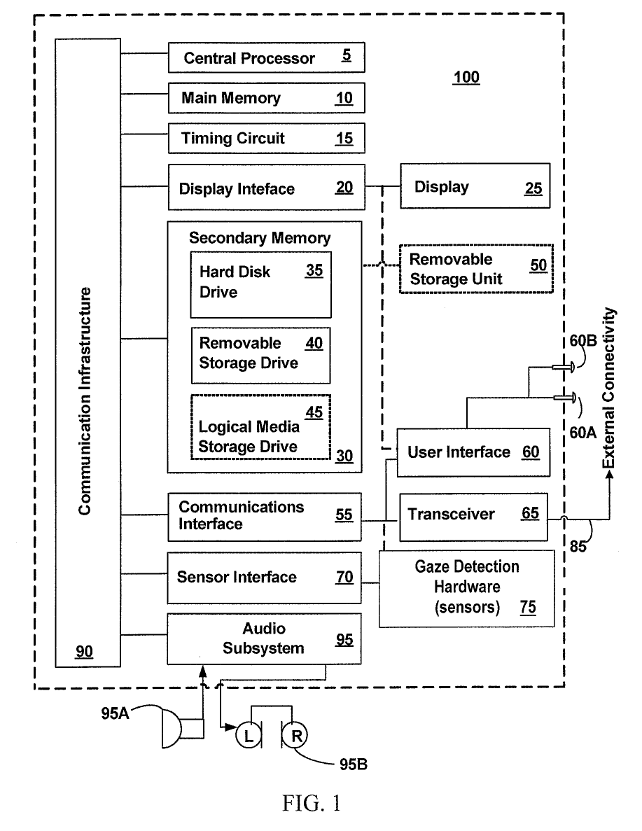

FIG. 1 illustrates a generalized block diagram of a portable media player 100 according to at least one embodiment of the invention. The portable media player 100 includes a communications infrastructure 90 used to transfer data and memory addresses where data items are to be found and control signals among the various components and subsystems associated with the portable media player 100. A central processor 5 is provided to interpret and execute logical instructions stored in the main memory 10. The main memory 10 is the primary general-purpose storage area for instructions and data to be processed by the central processor 5. The main memory 10 is used in its broadest sense and includes RAM, EEPROM and ROM. A timing circuit 15 is provided to coordinate activities within the portable media player in near real time and to make time-based assessments of sensor data collected by sensors on board (or interfaced to) the portable media player. The central processor 5, main memory 10 and timing circuit 1 5 are directly coupled to the communications infrastructure 90.

A display interface 20 is provided to drive a display 25 associated with the portable media player 100. The display interface 20 is electrically coupled to the communications infrastructure 90 and provides signals to the display 25 for visually outputting both graphics and alphanumeric characters. The display interface may, for example, display music videos, movies, and personal photographs access from memory of the portable media player. The display interface may also, for example, display textual play lists of songs or other media items upon the portable media player. The display interface may further display user interface controls and/or menus for interacting with the software of the portable media player and/or provide a menu of available simulated instruments from which a user may select via graphical user interface options. The display interface may be selectively be turned on or turned off. The display interface may also include variable illumination level capabilities to display content at various illumination levels. The display interface is generally attached to the casing of the portable media player. The display interface 20 may include a dedicated graphics processor and memory to support the displaying of graphics intensive media. The display 25 may be of any type (e.g., cathode ray tube, gas plasma) but in many circumstances will usually be a solid-state device such as liquid crystal display.

A secondary memory subsystem 30 is provided that houses retrievable storage units such as a hard disk drive 35, a removable storage drive 40, an optional logical media storage drive 45 and an optional removal storage unit 50. One skilled in the art would appreciate that the hard drive 35 may be replaced with flash memory. The secondary memory may be used to store a plurality of media files, including but not limited to a plurality of digital videos, digital songs, digital pod casts, a plurality of digital images, a plurality of personal photographs, a plurality of music videos, a plurality of other videos.

The removable storage drive 40 may be a replaceable hard drive, optical media storage drive or a solid-state flash RAM device. The logical media storage drive 45 may include a flash RAM device, an EEPROM encoded with playable media, or optical storage media (CD, DVD). The removable storage unit 50 may be logical, optical or of an electromechanical (hard disk) design.

A communications interface 55 subsystem is provided that allows for standardized electrical connection of peripheral devices to the communications infrastructure 90 including, serial, parallel, USB, and Firewire™ connectivity. For example, a user interface 60 and a transceiver 65 are electrically coupled to the communications infrastructure 90 via the communications interface 55. For purposes of the embodiments discussed herein, the term “user interface” 60 includes the hardware and operating software by which a user interacts with the portable media player 100 and the means by which the portable media player conveys information to the user and may include the display 25.

The transceiver 65 facilitates the remote exchange of data and synchronizing signals between the portable media player 100 and other devices in processing communications 85 with the portable media player 100. The transceiver 65 is envisioned to be of a radio frequency type normally associated with computer networks for example, wireless computer networks based on BlueTooth™ or the various Institute of Electrical and Electronics Engineers (“IEEE”) standards 802.11x, where “x” denotes the various present and evolving wireless computing standards, such as Worldwide Interoperability for Microwave Access (“WiMax”) 802.16 and Wireless Regional Area Networks (“WRAN”) 802.22. Alternately, digital cellular communications formats compatible with, for example, Global System for Mobile Communications (“GSM”), 3G and evolving cellular communications standards. Both peer-to-peer (“PPP”) and client-server models are envisioned for implementation of the invention. In a third alternative embodiment, the transceiver 65 may include hybrids of computer communications standards, cellular standards and evolving satellite radio standards.

The user interface 60 employed on the portable media play 100 may include a pointing device (not shown) such as a mouse, thumbwheel or track ball, an optional touch screen (not shown); one or more push-button switches 60A, 60B; one or more sliding or circular rheostat controls (not shown) and one or more switches (not shown). The user interface 60 provides interrupt signals to the processor 5 that may be used to interpret user interactions with the portable media player 100 and may be used in conjunction with the display 25.

The portable media player also includes a specialized gaze detecting sensor 75 as part of the gaze determining system, the gaze determining sensor being used to detect if the user's gaze is present at, within, or substantially near a defined visual display area of the portable media player. In some embodiments the gaze determining sensor 75 includes an emitter for reflecting electromagnetic energy off the eyes of a user within certain proximity. In some such embodiments the gaze detecting sensor detects and/or measures the reflected electromagnetic energy off the eyes of a user if that user is within certain proximity and/or looking in certain directions with respect to the portable media player Thus the portable media player includes one or more gaze detecting sensors 75 as part of an integrated gaze determining system for determining if a users gaze is directed at, within, or substantially near a visual display area of the portable media player. The sensors are supported by a sensor interface 70 that allows one or more sensors 75 to be operatively coupled to the communications infrastructure 90. The sensor interface 70 may monitor interactions with the user interface 60. For example, the sensor interface 70 may also be used to monitor a user's interaction with the one or more push-button switches 60A, 60B. An interrupt circuit may be incorporated into the hardware supporting the communications infrastructure 90. The gaze detecting sensor(s) 75 are generally installed within or upon the case (not shown) of the portable media player 100 (or a portion thereof) such that sensor is fixed with respect to a visual display area of the portable media player and oriented such that the sensor can detect a users gaze during normal viewing activities. In some embodiments the gaze detecting sensor is positioned to the side of a visual display area of the portable media player. In some embodiments the gaze-determining sensor is positioned behind a display screen and may capture gaze-determining data through a transparent or semi-transparent portion of the screen.

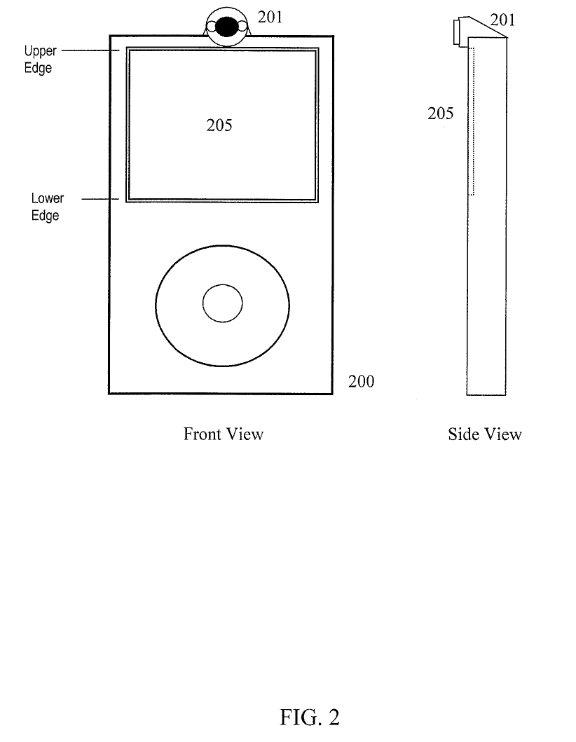

FIG. 2 illustrates a portable media player 200 equipped with a gaze-detecting sensor 201 of a gaze determining system integrated into to the casing according to at least one embodiment of the invention. The media player is shown from a front view and a side view. The gaze detecting sensor 201 may take many forms and have many orientations with respect to a display area of the portable media player. In FIG. 2 it is shown as being positioned centered and above the display screen 205 of the portable media players such that it has a clear line of sight orientation with respect to a user's eyes during normal viewing usage. The configuration of the gaze detecting sensor is such that it can determine whether or not a user who is within a nominal viewing distance of the screen is gazing in a direction that is aimed at, within, or substantially near a defined visual display area of the portable media player.

Referring back to FIG. 1, an audio subsystem 85 is provided and electrically coupled to the communications infrastructure 90. The audio subsystem provides for the playback and recording of digital media, for example, multi or multimedia encoded in any of the exemplary formats MP3, AVI, WAV, MPG, QT, WMA, AIFF, AU, RAM, RA, MOV, MIDI, and so forth. The audio subsystem includes a microphone input port 95A for input of voice commands and a headphone, headset, ear buds or speaker output 95B. Connection of the microphone 95A and/or headphones 95B includes both traditional cable and wireless arrangements such as BlueTooth™ are known in the relevant art. As referred to herein, “media” refers to video, audio, streaming and any combination thereof.

In addition, the audio subsystem is envisioned to optionally include features such as graphic equalization, volume, balance, fading, base and treble controls, surround sound emulation, and noise reduction. One skilled in the art will appreciate that the above-cited list of file formats is not intended to be all-inclusive.

The portable media player 100 includes an operating system, the necessary hardware and software drivers necessary to fully utilize the devices coupled to the communications infrastructure 90, media playback and recording applications and at least one control program 240 operatively loaded into the main memory 10. The control program may perform multiple functions, for example perform the automatic selection of media items from a plurality of media items stored in memory. The control program may also, for example, perform the automatic population of play lists and/or the automatic re-ordering of play lists. The control program also processes play lists, playing songs and/or displaying images in accordance with the sequential requirements of one or more play lists stored in memory. In some embodiments the play lists are downloaded from external sources. The control program manages such downloading processes. The control program also manages the downloading of new media items into the memory of the portable media player.

The control program is also operative to perform various functions according to embodiments of this invention. For example, the control program is operative to monitor the gaze detection sensor and store data from the sensor in memory over time. The control program may also read data from timing circuit 15. The control program may also filter and/or time-average the sensor data. The control program processes the sensor data and determines based upon the time varying characteristics of the sensor data whether or not to dim, turn off, or otherwise reduce the power sent to visual display hardware in response to the detected presence or absence of a user's gaze at, within, or substantially near the visual display area. In many embodiments as described herein the determination is based upon time varying characteristics of the detected gaze, such as the gaze being absent for more than a look-away time threshold and/or the gaze being present for more than a resume time threshold.

References to the at least one control program 240 may be made in both singular and plural form. No limitation is intended by such grammatical usage as one skilled in the art will appreciate that multiple programs, objects, subprograms routines, algorithms, applets, contexts, etc. may be implemented programmatically to implement the various embodiments of the invention.

The control program may also perform predictive functions, automatically selecting media items for the user that are statistically likely for the user to be in the mood for at a given time. A detailed discussions of the at least one control program 240 that performs predictive functions are provided in U.S. Provisional Patent Applications Ser. No. 60/651,771 filed on Feb. 9, 2005, and U.S. patent application Ser. No. 11/267,079 filed on Nov. 3, 2005 to the instant inventor, both of which are hereby incorporated by reference in their entirety. Optionally, the portable media player 100 is envisioned to include at least one remote authentication application, one or more cryptography applications capable of performing symmetric and asymmetric cryptographic functions, and secure messaging software (not shown.)

In some embodiments of the present invention, the user may selectively override the automatic screen dimming (or shut off) features of the present invention if he or she wants to (a) dim or turn off the visual display while gazing at, upon or substantially near the display area or (b) maintain normal display output characteristics while not gazing at, upon, or substantially near the display area.

In some preferred embodiments of the present invention the method for dimming and/or turning off the illumination of a display portion of a portable media player and/or reducing power consumed by display related components of the portable media player is performed in response to a determination that a user gaze has not been detected upon, within, or substantially near a display portion of the portable media player for more than a first threshold amount of time. In this way a user may glance away from the screen for less than the first threshold amount of time and not have the display be dimmed and/or turned off. Similarly, in some preferred embodiments of the present invention the method for resuming the normal display of video upon a portable media player after a user has looked away includes determining that the user has returned his gaze upon, within, or substantially near a display portion of the portable media player for more than a second threshold amount of time. In this way a user may momentarily glance upon the display and not have it turn on unless the glance lasts for more than the second threshold amount of time. In some embodiments, the first threshold and the second threshold are set to the same amount of time and may simply be referred to as the threshold amount of time. In most preferred embodiments the first threshold is set to a substantially longer amount of time than the second threshold. This allows the portable media player visual display to automatically dim and/or turn off after the user has looked away for longer period of time than is require for the user to return his or her gaze to the visual display and cause the visual display to return to a standard illumination level.

Thus one aspect of the present invention is the use of a time threshold such that display screen is not dimmed and/or turned off unless it is determined by the gaze determination hardware and software of the present invention that the user has looked away from a visual display area for more than a first threshold amount of time. In some embodiments of the present invention, the first threshold amount of time is set to 6 seconds. This threshold is referred to herein as a look-away time threshold.

In some embodiments the illumination level is dimmed over a period of time, either continuously or in discrete steps, until it reaches final dimmed illumination level. In many embodiments the final dimmed illumination level may be such that no illumination is produced by the display, thereby conserving at a maximized level. The period of time over which the illumination is dimmed is referred to herein as a dimming time and it may, for example, be set to 30 seconds.

Upon determining using the gaze determination hardware and software of the present invention that a user has looked away from the visual display area for more than the look-away threshold amount of time, the visual display is dimmed and/or turned off (while the audio continues to play) by the control software of the present invention until it is determined that the user's gaze has returned to the visual display area. In some embodiments a second time threshold value is used such that the user must return his or her gaze to the visual display area for more than this second time threshold amount of time for the visual display to return to a standard illumination level. This prevents the illumination level from resuming in response to a fleeting glance from the user. In general this second amount of time is selected to be long enough such that it will not trigger a change in the display illumination characteristics by fleeting glance, but short enough that a user does not feel like time is being wasted while he or she waits for the visual display characteristics to resume to a standard viewable configuration. In some embodiments this second threshold amount of time is set to 1750 milliseconds. This second threshold is referred to herein as a resume time threshold.

In some embodiments the visual display characteristics are returned to a standard viewing configuration (i.e., illumination level) immediately. In other embodiments the display characteristics are gradually returned to a standard viewing configuration over a period of time referred to herein as a resume transition time. In some embodiments the resume transition time is 1500 milliseconds. In such embodiments the control software of the present invention ramps up the illumination level from the final dimmed illumination level to the standard viewing illumination level over the resume transition time. The ramping may be performed linearly over the time period or non-linearly. In general the time profile of ramping is selected to be pleasing to users—not too abrupt, but not too slow. A pleasing configuration is sometimes exponential, ramping at an increasing rate over time thereby avoiding too abrupt of an initial change but reaching the final illumination level in a manner that is perceived as quite rapid by the user.

In many such embodiments the threshold time used to turn off the screen is longer than the threshold time to turn on the screen (as in the examples above). This is because the user often desires the screen to come on quickly when he or she brings it into a convenient viewing orientation but does not need the screen to turn off quickly when the user moves the screen into an orientation that is not conducive to viewing.

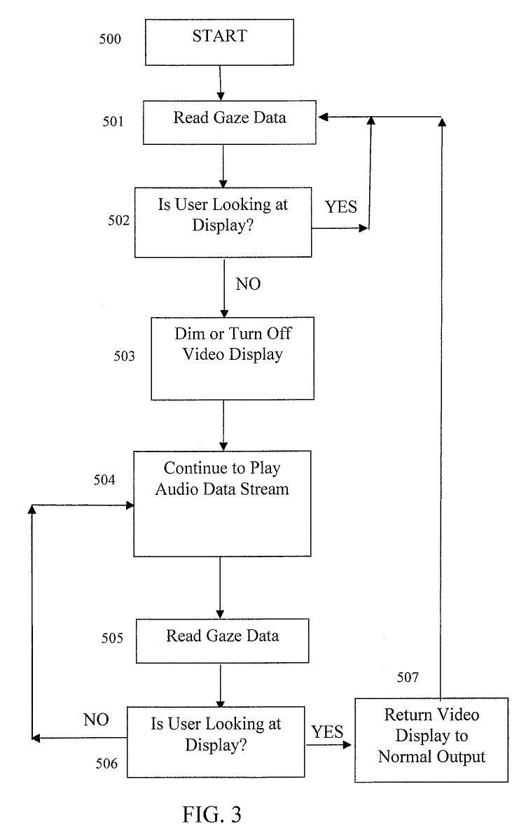

FIG. 3 illustrates an exemplary flow chart for an example power conservation method according to at least one embodiment of the invention. The process begins at step 500 where it is assumed that an audio-video media file is currently being accessed and played, the media player conveying both audio and video content to the user. The accessing of the media file from memory and the playing of the content through audio and video displays may be performed by a background process that runs in parallel with the power conservation program shown in the figure, the background process being affected by the power conservation process at certain steps.

Once started, the power conservation program proceeds to step 501 where the processor of the media player reads one or more gaze detection sensors on board the media player (or a portion thereof). As described previously the sensors are configured to detect and/or determine if a user's gaze is aimed at, upon, or substantially near a visual display area of the portable media player. Reading sensor data may include filtering, time averaging, and/or storing and accessing data over a period of time. In step 502, the software according to the present invention determines whether the user is looking at a display area of the portable media player. In general this step is performed such that the sensor data is processed to determine whether a user is gazing at, upon, or substantially near a visual display area of the media player. In general this determination may involve a processing of a time history of sensor data such that a user's gaze is determined to be at, upon, or substantially near a visual display area if sensor data indicates the presence of a user gaze for a time duration that exceeds a first threshold amount of time. Similarly, this determination may involve a processing of a time history of sensor data such that a user's gaze is determined NOT to be at, upon, or substantially near a visual display area if sensor data does not indicate the presence of a user gaze for a time duration that exceeds a second threshold amount of time. For example, if a user gaze has previously been determined to be present at, upon, or substantially near a visual display area of the portable media player, the software may be configured to check for a subsequent absence of such a gaze by processing of a time history of sensor data to determine whether the gaze is now absent and has been absent for a time duration that exceeds a second threshold amount of time.

If it is determined that a user gaze is still present, the software processing returns to 501, repeating the reading of sensor data while the media file continues to play normally, the video and audio content being displayed to the user. If it is determined that the user is no longer looking at the display area, the software jumps to 503 where the video display is turned off (or dimmed in illumination level) to conserve power as described previously. The process then proceeds to 504 where the audio content of the media file continues to play normally to the user. If the software triggers a power conservation mode, turning off (or dimming) the video display at 503 and continuing to play the audio content in the background to the user in a substantially unchanged manner, the process next proceeds to 505 as shown in the figure. At 505 the gaze-detecting sensor is read again. Reading sensor data may include filtering, time averaging, and/or storing and accessing data over a period of time. The process then proceeds to step 506 where the sensor data is processed to determine if the user is looking at the display area. If not, the process loops back to 504 wherein the audio stream continues to play to the user and the screen remains off or dimmed (as it was prior to this step). Thus for so long as it is determined that is not looking at the display area, the screen remains off (or dimmed) and the audio content continues to play normally. If, on the other hand, the process at 506 determines that the user it looking upon the screen area (i.e. the user has returned his gaze to the display area for more than a resume time threshold amount of time), the process proceeds to step 507 wherein the video display is returned to a normal output configuration. The process then returns to step 501 and the whole process repeats.

Thus the software process described herein may be configured to require that the user look away from the display area for more than a first threshold amount of time for the screen to be turned off (or dimmed) and then may require that the user look back upon the screen area for more than a second threshold amount of time for the screen to be returned to a normal display configuration. The first threshold amount of time may be, for example, 6 seconds. The second threshold amount of time may be, for example, 1750 milliseconds. In this way the screen is not turned on and/off based on mere transients in the data, instead requiring that the media player receive consistent gaze data over periods of time before screen display illumination changes are made. This avoids spurious changes to screen display illumination levels and makes for a user-friendly automated power conservation process.

Thus a user of an embodiment of the present invention may gaze upon the visual display area of his or her portable media player and watch the video content of a media file while listening to the audio content. The user may then decide to cease watching the video. Upon looking away from the display area for more than a look-away time threshold amount of time, the video screen will automatically dim and/or turn off conserving power. The audio content continues to play to the user through audio hardware (i.e., at a substantially unchanged power level). At some point in the future the user may hear something on the audio that makes him or her want to watch the video. He simply returns his gaze to the visual display area of the portable media player. Upon detecting his gaze for more than a resume time threshold amount of time, the video content is returned to the screen with normal viewing illumination. In some embodiments it is returned following a ramp-up in illumination over time. Thus, embodiments of the present invention allow for intelligent power consumption in a manner that enables a natural and intuitive user interaction. The user need not press buttons or make user interface selections to engage the power conservation. Instead the user simply needs to selectively look upon and/or look away from the visual display area of his or her portable media player.

In some embodiments the look-away time threshold is represented by two time thresholds referred to herein as a dimming look-away time threshold and a screen-off look-away time threshold. The dimming look-away time threshold is defined herein as an amount of time a user must look away from a the screen area for the software of the present invention to beginning dimming the illumination of the display screen. The screen-off look-away time threshold is defined herein as an amount of time that a user must look away from the screen area for the software according to the present invention to turn off the display screen. In general, the dimming look away time threshold is defined as a time duration that is shorter than the screen-off look-away time threshold. For example, the dimming look away time threshold may be defined as 6 seconds while the screen-off look-away time threshold may be defined as 30 seconds.

In some embodiments of the present invention one or more of the time thresholds defined herein may be user defined and/or selected and/or adjusted through a user interface of the portable media player.

This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art.

Other embodiments, combinations and modifications of this invention will occur readily to those of ordinary skill in the art in view of these teachings. Therefore, this invention is not to be limited to the specific embodiments described or the specific figures provided. This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A portable media player with gaze-responsive power conservation comprising:
a casing configured to be held in a hand of a user;
a processor disposed within the casing;
a visual display affixed to the casing;
an audio display;
a main memory functionally coupled to the processor;
a secondary memory functionally coupled to the processor, the secondary memory having media content retrievably stored therein;
a gaze sensor physically coupled to the casing and functionally coupled to the processor, the gaze sensor configured to transmit signals to the processor responsive to a gaze of a user;
a program operatively loaded into the main memory having instructions executable by the processor to:
present media content to a user by displaying visual content on the visual display and by playing audio content through the audio display;
reduce the power consumption of the visual display by lowering an intensity of display output in response to the gaze sensor indicating that the user is not gazing in the general direction of the visual display, while continuing to play audio content normally to the user through the audio display.

2. The portable media player according to claim 1, wherein the lowering the intensity of the display output comprises reducing a brightness of the display output.

3. The portable media player according to claim 1, wherein the lowering the intensity of the display output comprises turning off the visual display.

4. The portable media player according to claim 1, wherein the audio display comprises headphones or ear buds that are functionally coupled to the processor through a wired or wireless connection.

5. The portable media player according to claim 1, wherein the gaze sensor includes a camera element and a light source.

6. The portable media player according to claim 1, wherein the indicating that the user is not gazing in the general direction of the visual display comprises a determination that the user's gaze falls outside certain boundaries for more than a threshold amount of time.

7. The portable media player according to claim 6, wherein the certain boundaries correspond approximately to a screen area of the visual display.

8. The portable media player according to claim 1, wherein the program operatively loaded into the main memory is further operative to return the visual display to a non-reduced power consumption level in response to a determination that the user's gaze has returned to the general direction of the visual display.

9. The portable media player according to claim 8, wherein the return to the non-reduced power consumption of the visual display is dependent upon a time threshold such that the gaze sensor indicates that the user's gaze is within certain boundaries for more than a threshold amount of time.

10. The portable media player according to claim 9, wherein the certain boundaries correspond generally to an area of the visual display.

11. The portable media player according to claim 1, wherein reducing of the power consumption to the visual display is adapted to be overridden by the user performing at least one of: manually pressing a button of the portable media player, and otherwise engaging a manual user interface element of the portable media player.

12. A method of providing gaze-responsive power conservation for a portable media player, the method comprising:
providing a casing configured to be held in the hand of a user;
providing a processor disposed within the casing;
providing a visual display affixed to the casing;
providing an audio display;
providing a main memory functionally coupled to the processor;
providing a secondary memory functionally coupled to the processor, the secondary memory having media content retrievably stored therein;
providing a gaze sensor physically coupled to the casing and functionally coupled to the processor, the gaze sensor configured to transmit signals to the processor responsive to a gaze of a user;
providing a program operatively loaded into the main memory having instructions executable by the processor to:
present media content by displaying visual content on the visual display and by playing audio content through the audio display; and
reduce the power consumption of the visual display by lowering an intensity of display output in response to the gaze sensor indicating that the user is not gazing in the general direction of the visual display, while continuing to play audio content normally to the user through the audio display.

13. The method according to claim 12, wherein the lowering the intensity of the display output comprises reducing a brightness of the display output.

14. The method according to claim 12, wherein the lowering the intensity of the display output comprises turning off the display.

15. The method according to claim 12, wherein the gaze sensor includes a camera element and a light source.

16. The method according to claim 12, wherein the indicating that the user is not gazing in the general direction of the visual display comprises a determination that the user's gaze falls outside certain boundaries for more than a threshold amount of time.

17. The method according to claim 16, wherein the certain boundaries correspond approximately to the screen area of the visual display.

18. The method according to claim 12, wherein the program operatively loaded into the main memory is further operative to return the visual display to a non-reduced power consumption level in response to a determination that the user's gaze has returned to the general direction of the visual display.

19. The method according to claim 18, wherein the resumption of non-reduced power consumption of the visual display is dependent upon a time threshold such that the gaze sensor indicates that the user's gaze is within certain boundaries for more than a threshold amount of time.

20. The method according to claim 19, wherein the certain boundaries correspond generally to an area of the visual display.

21. A method of providing gaze-responsive power conservation for a portable media player, the method comprising:
providing a gaze sensor physically coupled to a casing of the portable media player and functionally coupled to a processor of the portable media player, the gaze sensor being configured to transmit signals to the processor in response to a gaze of a user; and
reducing power consumption of a visual display of the portable media player in response to the gaze sensor indicating that the user is not gazing in a general direction of the visual display, while continuing to play audio content to the user through an audio display.

22. The method of claim 21, wherein the reducing power consumption of the visual display comprises at least one of: dimming the visual display, and turning off the visual display.

23. The method according to claim 21, wherein the indicating that a user is not gazing in the general direction of the visual display comprises a determination that the user's gaze falls outside certain boundaries more than a threshold amount of time.

24. The method according to claim 23, wherein the media player is further operative to return the power consumption of the visual display to a non-reduced level in response to the gaze sensor indicating that the user's gaze has returned to the general direction of the visual display.
